(19) United States
(12) Patent Application Publication
(10) Pub. No.: US 2007/0149903 A1
(43) Pub. Date: Jun. 28, 2007

(54) Massage apparatus with exchangeable actuators

(75) Inventor: Simon Siu Man Nan, Richmond Hill (CA)

Correspondence Address: GREENSFELDER HEMKER & GALE PC, SUITE 2000, 10 SOUTH BROADWAY, ST LOUIS, MO, 63102, US

(73) Assignee: NANMA MANUFACTURING CO. LTD., Chai Wan (HK)

(21) Appl. No.: 11/315,021

(22) Filed: Dec. 22, 2005

(51) Int. Cl. A61H 1/00

(52) U.S. Cl. 601/72; 601/46; 601/70; 601/80; 601/112

(57) ABSTRACT

A massage apparatus capable of exchanging massage actuators is disclosed. The massage apparatus may include a power-driving unit adapted to operatively engage or operatively disengage with an actuator unit having at least one massage actuator such that another actuator unit may be operatively engaged with the power-driving unit.

### FIELD

The present document relates to a massage apparatus, and more particularly to a massage apparatus capable of engaging and disengaging a massage actuator.

### SUMMARY

In one embodiment, a massage apparatus comprises a power-driving unit, the power-driving unit being operatively engaged to a removable battery compartment for providing a power source for the massage apparatus, and an actuator unit adapted to be operatively engaged to the power-driving unit, wherein the actuator unit is adapted to be engaged or disengaged from the power-driving unit such that another actuator unit may be operatively engaged to the power-driving unit.

In another embodiment, a massage apparatus comprises a power-driving unit adapted for operative engagement with an actuator unit, the actuator unit including at least one massage actuator for providing a vibration function when driven by the power-driving unit, the actuator unit including a power-transmitting shaft having a distal end and a proximal end, the distal end of the power-transmitting shaft being operatively engaged to the at least one massage actuator and the proximal end of the power-transmitting shaft being operatively engaged to the power-driving unit, wherein the actuator unit is adapted to be engaged or disengaged from the power-driving unit by engaging or disengaging the power-transmitting shaft from the power-driving unit such that another actuator unit may be operatively engaged to the power-driving unit.

In yet another embodiment, a method of engaging and disengaging a massage actuator for a massage apparatus comprises:

a) providing a massage apparatus comprising a power-driving unit adapted for operative engagement with an actuator unit, the actuator unit including at least one massage actuator, the actuator unit including a power-transmitting shaft having a distal end and a proximal end, the distal end being operatively engaged to the at least one massage actuator and the proximal end being operatively engaged to the power-driving unit.

b) disengaging the proximal end of the power-transmitting shaft from the power-driving unit;

c) providing another actuator unit, the another actuator unit including at least one massage actuator having a power-transmitting shaft defining a proximal end adapted to be engaged to the power-driving unit; and

d) engaging the proximal end of the power-transmitting shaft to the power-driving unit.

In one embodiment, a massage apparatus comprises a power-driving unit, the power-driving unit being in operative engagement with an actuator unit, the actuator unit having at least one massage actuator, wherein the actuator unit is adapted to be engaged or disengaged from the power-driving unit such that another actuator unit may be operatively engaged to the power-driving unit.

Implementations of the above embodiments may include one or more of the following features:

The actuator unit is adapted to be encased inside an actuator cover.

The actuator cover defines a hollow main sleeve in communication with a hollow secondary sleeve, wherein the at least one massage actuator is adapted to be disposed inside the hollow main sleeve.

The actuator unit includes at least one massage actuator with the at least one massage actuator including a first massage component adapted to provide a squirming action when made operational.

The at least one massage actuator includes a shaft having a distal end and a proximal end with the first massage component being operatively engaged to the distal end of the shaft such that the first massage component freely rotates about the distal end.

The shaft has a first axis and the first massage component has a second axis that is in misalignment with the first axis of the shaft such that rotation of the shaft generates the squirming action by the first massage component.

The actuator unit further includes a power-transmitting shaft having a distal end and a proximal end with the distal end of the power-transmitting shaft defining a circular portion and the proximal end of the power-transmitting shaft defining a center square hole.

The power-driving unit comprises a motor gearbox assembly having a motor including a shaft that defines square-shaped end adapted to operatively engage the center square hole of the power-transmitting shaft such that the power-transmitting shaft may be rotated.

The actuator unit may be engaged or disengaged from the power-driving unit by engaging or disengaging the power-transmitting shaft from the shaft of the motor.

The at least one massage actuator comprises a second massage component with the second massage component being operatively associated with the actuator unit for providing a vibration function.

The second massage component includes a motor operatively engaged to a shaft rotatably engaged to an eccentric mass that is spun by the shaft when rotated by the motor.

The power-driving unit comprises a control panel with the control panel being adapted to control the operation of the at least one massage actuator.

The power-driving unit is adapted to engage a sealing element for providing a water-tight seal between the actuator unit and the power-driving unit.

The removable battery compartment includes a battery carrier adapted to engage a battery cover.

The battery carrier defines a plurality of compartments with each of the plurality of compartments being adapted to operatively engage a respective battery therein.

Additional features will be set forth in the description which follows, and will become apparent to those skilled in the art upon examination of the following more detailed description and drawings in which like elements of the invention are similarly numbered throughout.

### BRIEF DESCRIPTION OF THE DRAWINGS

FIG. 1 is a perspective view of the massage apparatus;

FIG. 2 is a partial exploded view of the main components of the massage apparatus;

FIG. 3 is an exploded view of the actuator unit for the massage apparatus;

FIG. 4 is an exploded view of the driving unit for the massage apparatus; and

FIG. 5 is an exploded view of the removable battery compartment.

Corresponding reference characters indicate corresponding elements among the view of the drawings.

### DETAILED DESCRIPTION

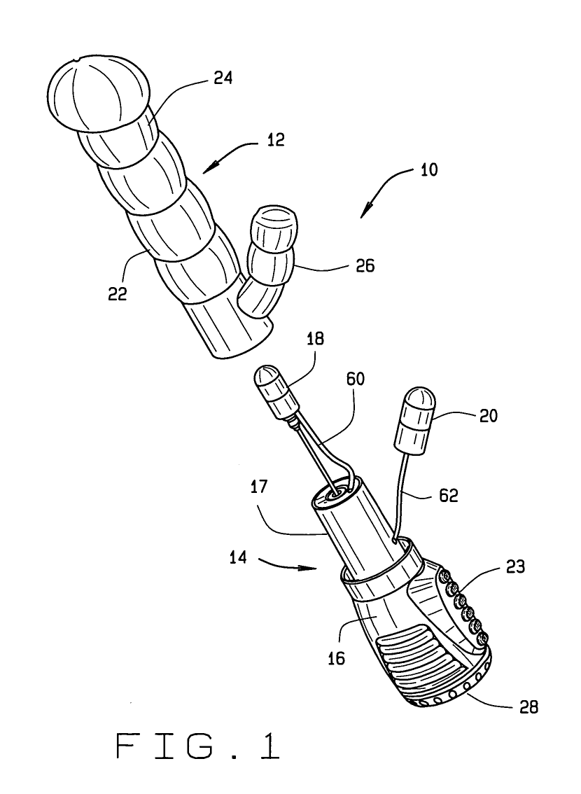

Referring to the drawings, an embodiment of a massage apparatus is illustrated and generally indicated as 10 in FIGS. 1-5. In one embodiment, the massage apparatus 10 may include a power-driving unit 16 adapted to be operatively engaged to an actuator unit 17. The power-driving unit 16 drives and controls the operation of the actuator unit 17 for providing one or more massage functions. A removable battery compartment 28 may be adapted to operatively engage the power-driving unit 16 for providing a power source.

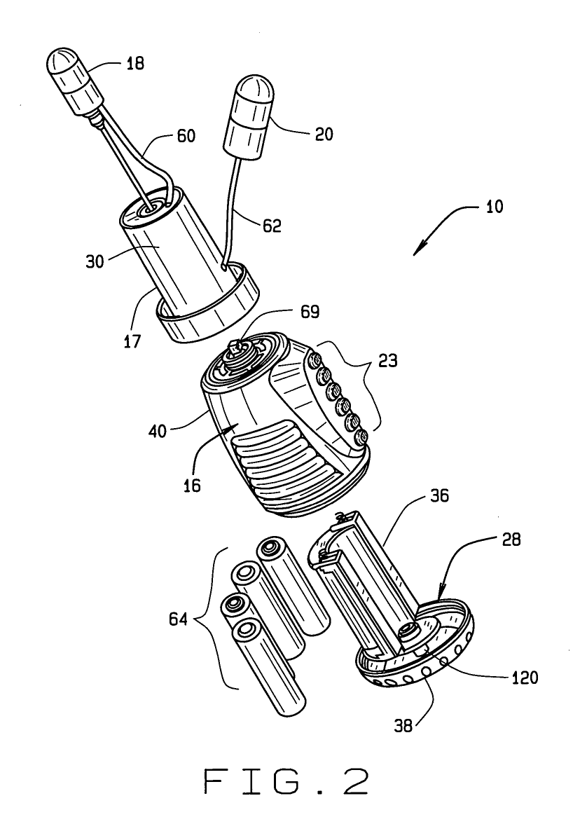

Referring to FIGS. 1 and 2, the power-driving unit 16 may be adapted to be engaged and disengaged from the actuator unit 17. In addition, the actuator unit 17 includes an actuator housing 30 and is adapted to be encased inside an actuator cover 12. In one embodiment, the actuator cover 12 includes a body 22 that may be made from a hollow, resilient material that is adapted to encase the power-driving unit 16 and form an external resilient outer layer that applies a squirming and/or vibration functions of the massage apparatus 10 to the user. As shown, the body 22 of actuator cover 12 may define a hollow main sleeve 24 in communication with a hollow secondary sleeve 26 extending outwardly from main sleeve 24 of actuator cover 12.

In one embodiment, the power-driving unit 16 may be operatively associated with a first massage component 18 for providing a squirming massage function and a second massage component 20 that may provide a vibrating massage function. The main sleeve 24 of the actuator cover 12 defines an internal chamber (not shown) adapted to receive the first massage component 18 therein, while the secondary sleeve 26 has an internal chamber (not shown) adapted to receive the second massage component 20 therein. When the first massage component 18 is made operational a squirming action is generated that imparts a different massage function than the second massage component 20 which utilizes a different mechanical arrangement to produce a different massaging action as shall be discussed in greater detail below.

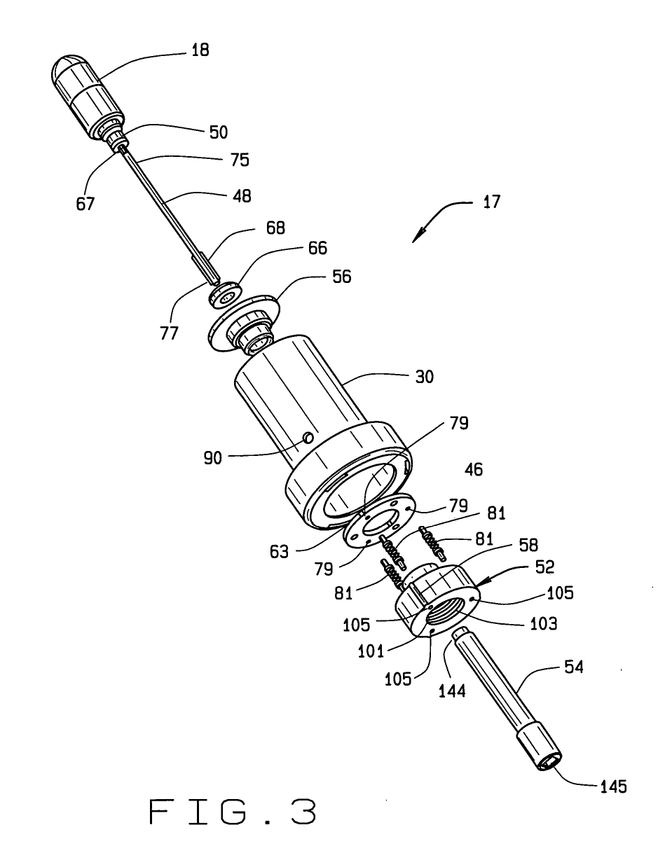

Referring to FIG. 3, the first massage component 18 may include an electric motor (not shown) that rotates a motor shaft having an eccentric mass mounted thereon. Operation of the electric motor causes the eccentric mass to spin due to the rotation of the motor shaft which generates a high frequency vibration action. In addition, the first massage component 18 may include a cylindrical portion 50 extruded axially from the massage component 18 adapted to engage a shaft 48 defining a distal end 75 and a proximal end 77. The cylindrical portion 50 defines a center hole 67 adapted to operatively engage the distal end 75 of shaft 48 such that the first massage component 18 freely rotates about shaft 48 and the first massage component 18 is axially restricted to move along shaft 48.

Shaft 48 may be operatively engaged to first massage component 18 such that shaft 48 has a first axis and the first massage component 18 has a second axis. Because there is a misalignment between the first and second axes rotation of shaft 48 generates a squirming action when the first massage component 18 is actuated.

As further shown, the proximal end 77 of shaft 48 may define a knurling portion 68 that is operatively engaged in an interference fitting to a center hold (not shown) defined by a circular portion 144 defined at a distal end of a power-transmitting shaft 54. In addition, the power-transmitting shaft 54 may further define a center square hole 145 at the proximal end of the power-transmitting shaft 54. A retaining ring 66 may be adapted to engage circular portion 144 in an interference fitting in order to retain the proximal end 77 of shaft 48 inside the actuator housing 30 of actuator unit 17.

A flange end cap 56 may cover one end of the actuator housing 30 for supporting retaining ring 66, while a holding plate 46 may be disposed at the opposing end of actuator housing 30. As shown, holding plate 46 may have a generally cylindrical body defining a key portion 63 extruded radially along the circumference of plate 46 and a plurality of through-holes 79 that may be defined through and evenly distributed about the body of plate 46 in one embodiment.

In addition, loaded springs 81 having contact poles 83A and 83B may be located at respective opposing ends. of each spring 81. In assembly, the contact pole 83A of each loaded spring 81 may be inserted through a respective hole 79 and may be soldered to electrical wires 60, 62 (FIG. 1) which are operatively associated to the first and second massage components 18 and 20, respectively, in order to provide power and control functions. Actuator housing 30 may define an aperture 90 adapted to permit entry of electrical wire 62 into actuator unit 17.

As further shown, a flange plug 52 may include a center hole 103 defining internal threads 101 and a plurality of stepped-through holes 105 evenly distributed along the body of plug 52. Further, the flange plug 52 may define a key portion 58 extruded radially along the circumference of plug 52. During assembly, the contact pole 83B of each spring 81 may be adapted to be inserted into one of the stepped-through holes 105 at one end thereof such that the contact pole 83B extends a certain length from each hole 105, thereby establishing a spring loaded contact point.

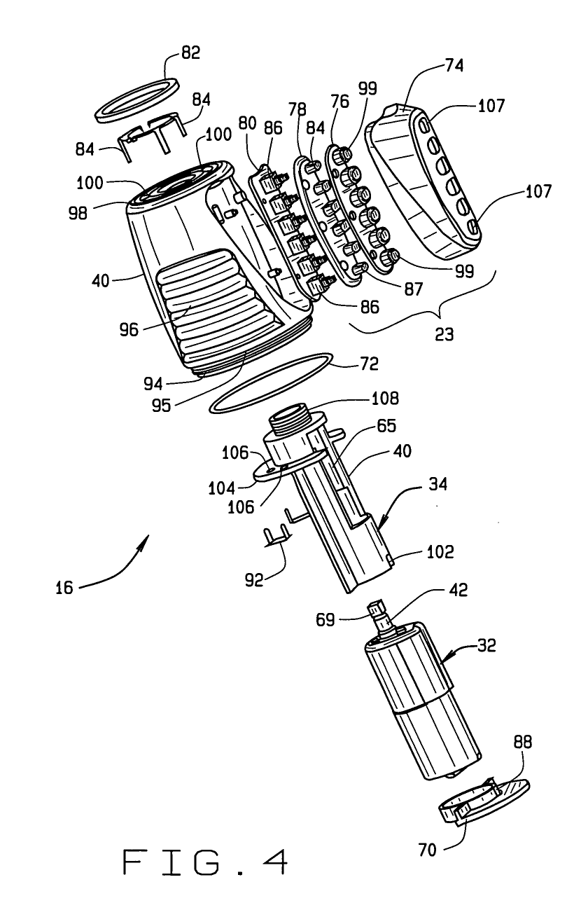

Referring to FIG. 4, power-driving unit 16 may include a control panel 23 operatively associated with the first and second massage components 18, 20 as well as a gearbox assembly 32 for controlling the operation of the massage apparatus 10. The control panel 23 may include a printed circuit board 80 operatively connected to a plurality of push buttons 86 that control various control functions of the massage apparatus 10. A plurality of push button caps 87, which may be made of a rigid material, are loosely carried by a clamping plate 78 that secures the printed circuit board 80 to the body of the power-driving unit 16 using screws (not shown) or other attachment means.

A push button cover 76 may be made of a resilient material that defines a plurality of cavities 99 which may be sized and shaped to accommodate push button caps 87 placed over the clamping plate 78. The control panel 23 may further include a panel 74 adapted to encase the push button cover 76. As further shown, the panel 74 defines apertures 107 adapted to accommodate each cavity 99.

The power-driving unit 16 may further include motor gearbox assembly 32 disposed within a gearbox holding frame 34 for driving the first massage component 18. Specifically, the motor gearbox assembly 32 may include a motor (not shown) that drives a rotatable shaft 42 defining a square-shaped end 69 adapted to operatively engage the center square hole 145 and rotate power-transmitting shaft 54.

The gearbox holding frame 34 may include a body 40 that defines a chamber 65 adapted to receive the motor gearbox assembly 32. As shown, the body 40 may define external threads 108 at one end and a notch 102 defined at the opposing end of frame 34. Body 40 may also include a flange portion 104 having a semi-circular configuration defining a plurality of through-hole slots 106. Contact plates 92 may be engaged through the through-hole slots 106 along the face of flange portion 104.

In addition, an end cap 70 having a location key 88 may be adapted to engage the gearbox holding frame 34. This is accomplished by the engagement of the location key 88 with notch 102 such that the motor gearbox assembly 32 is retained within the gearbox holding frame 34.

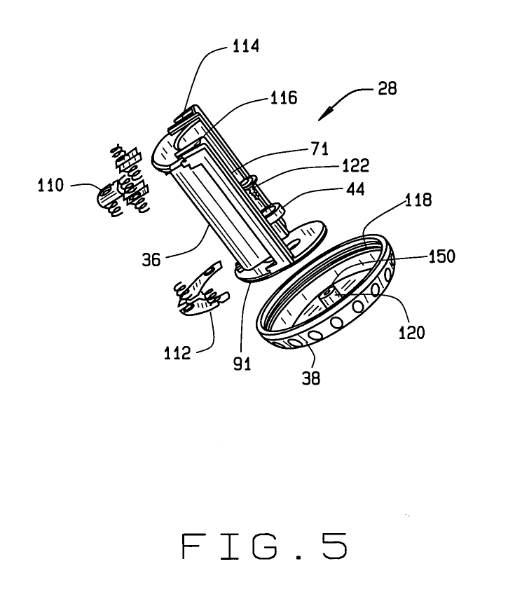

As further shown, the power-driving unit 16 may include a circular slot 98 adapted to engage a sealing element 82 for providing a water-tight seal between the actuator housing 30 and the power-driving unit 16. Three pairs of through-hole slots 100 are defined by body 40 for engagement with three respective contact plates 84. Body 40 may further include a plurality of protrusions 96 located on either side of body 40 which are adapted to provide an ergonomic and non-slippery gripping surface for the user. In addition, body 40 may define external threads 94 and a shoulder 95 adapted to engage a sealing element 72 for providing a water-tight seal between body 40 and battery cover 38 (FIG. 5).

Referring to FIG. 5, the massage apparatus 10 may further include a removable battery compartment 28 that is adapted to be operatively engaged with body 40 of the power-driving unit 16 for providing a power source to massage apparatus 10. Removable battery compartment 28 may include a battery carrier 36 adapted to engage battery cover 38. The battery cover 38 may define internal threads 118 adapted to engage the external threads 94 of the power-driving unit 16 in order to secure the battery cover 38 to body 40. In addition, the battery cover 38 includes a boss 120 that defines a center hole 150, while the battery carrier 36 defines a compartment 71 each adapted to engage the gearbox holding frame 34 (FIG. 2) therein. The battery carrier 36 may define an outer circumferential space to engage batteries 64.

As further shown, battery carrier 36 may define a cylindrical portion 44 adapted for locating screw 122, while spring clips 114, 116 may be adapted for locating respective spring contacts 110. The battery carrier 36 may include a side slot 91 for locating spring contacts 112. In assembly, the battery carrier 36 is secured by screw 122 along the center hole 150 of boss 120 defined by battery cover 38 such that the battery cover 38 is rotatable relative to battery carrier 36.

It should be understood from the foregoing that, while particular embodiments have been illustrated and described, various modifications can be made thereto without departing from the spirit and scope of the invention as will be apparent to those skilled in the art. Such changes and modifications are within the scope and teaching of this invention as defined in th claims appended hereto.

What is claimed:

1. A massage apparatus comprising:
a power-driving unit, said power-driving unit being operatively engaged to a removable battery compartment for providing a power source for the massage apparatus, and
an actuator unit adapted to be operatively engaged to the power-driving unit, wherein said actuator unit is adapted to be engaged or disengaged from said power-driving unit such that another actuator unit may be operatively engaged to said power-driving unit.

2. The massage apparatus according to claim 1, wherein said actuator unit is adapted to be encased inside an actuator cover.

3. The massage apparatus according to claim 2, wherein said actuator cover defines a hollow main sleeve in communication with a hollow secondary sleeve, wherein said at least one massage actuator is adapted to be disposed inside said hollow main sleeve.

4. The massage apparatus according to claim 1, wherein said actuator unit includes at least one massage actuator, said at least one massage actuator includes a first massage component adapted to provide a squirming action when made operational.

5. The massage apparatus according to claim 4, wherein said at least one massage actuator includes a shaft having a distal end and a proximal end, said first massage component being operatively engaged to said distal end of said shaft such that the first massage component freely rotates about said distal end.

6. The massage apparatus according to claim 5, wherein said shaft has a first axis and said first massage component has a second axis that is in misalignment with the first axis of said shaft such that rotation of said shaft generates said squirming action by said first massage component.

7. The massage apparatus according to claim 5, wherein said actuator unit further includes a power-transmitting shaft having a distal end and a proximal end, said distal end of said power-transmitting shaft defines a circular portion and the proximal end of said power-transmitting shaft defines a center square hole.

8. The massage apparatus according to claim 7, wherein said power-driving unit comprises a motor gearbox assembly having a motor including a shaft that defines square-shaped end adapted to operatively engage said center square hole of said power-transmitting shaft such that said power-transmitting shaft may be rotated.

9. The massage apparatus according to claim 8, wherein said actuator unit may be engaged or disengaged from said power-driving unit by engaging or disengaging the power-transmitting shaft from said shaft of said motor.

10. The massage apparatus according to claim 1, wherein at least one massage actuator comprises a second massage component, said second massage component operatively associated with said actuator unit for providing a vibration function.

11. The massage apparatus according to claim 10, wherein said second massage component includes a motor operatively engaged to a shaft rotatably engaged to an eccentric mass that is spun by the shaft when rotated by said motor.

12. The massage apparatus according to claim 1, wherein said power-driving unit comprises a control panel, said control panel being adapted to control the operation of said at least one massage actuator.

13. The massage apparatus according to claim 1, wherein said power-driving unit is adapted to engage a sealing element for providing a water-tight seal between said actuator unit and said power-driving unit.

14. The massage apparatus according to claim 1, wherein said removable battery compartment includes a battery carrier adapted to engage a battery cover.

15. The massage apparatus according to claim 14, wherein said battery carrier defines a plurality of compartments, each of said plurality of compartments being adapted to operatively engage a respective battery therein.

16. A massage apparatus comprising:
a power-driving unit adapted for operative engagement with an actuator unit, said actuator unit including at least one massage actuator for providing a vibration function when driven by said power-driving unit, said actuator unit including a Simon Siu Man NAN 69199.88042 power-transmitting shaft having a distal end and a proximal end, said distal end of said power-transmitting shaft being operatively engaged to said at least one massage actuator and said proximal end of said power-transmitting shaft being operatively engaged to said power-driving unit, wherein said actuator unit is adapted to be engaged or disengaged from said power-driving unit by engaging or disengaging the power-transmitting shaft from said power-driving unit such that another actuator unit may be operatively engaged to said power-driving unit.

17. The massage apparatus according to claim 16, wherein said at least one massage actuator includes a first massage component, said first massage component including a shaft operatively engaged to said distal end of said power-transmitting shaft.

18. The massage apparatus according to claim 17, wherein said power-driving unit comprises a motor gearbox assembly having a motor including a shaft adapted to engage the proximal end of said power-transmitting shaft.

19. The massage apparatus according to claim 18, wherein said actuator unit may be engaged or disengaged from said power-driving unit by engaging or disengaging said proximal end of said power-transmitting shaft from said shaft of said motor.

20. A method of engaging and disengaging a massage actuator for a massage apparatus comprising:
a) providing a massage apparatus comprising a power-driving unit adapted for operative engagement with an actuator unit, said actuator unit including at least one massage actuator, said actuator unit including a power-transmitting shaft having a distal end and a proximal end, said distal end being operatively engaged to said at least one massage actuator and said proximal end being operatively engaged to said power-driving unit.
b) disengaging said proximal end of said power-transmitting shaft from said power-driving unit;
c) providing another actuator unit, said another actuator unit including at least one massage actuator having a power-transmitting shaft defining a proximal end adapted to be engaged to said power-driving unit; and
d) engaging said proximal end of said power-transmitting shaft to said power-driving unit.

21. The method according to claim 20, wherein said power-driving unit comprises a motor having a rotatable shaft, said rotatable shaft being adapted to engage or disengage with said proximal end of said power-transmitting shaft when engaging or disengaging said actuator unit with said power-driving unit.

22. A massage apparatus comprising:
a power-driving unit, said power-driving unit being in operative engagement with an actuator unit, said actuator unit having at least one massage actuator, wherein said actuator unit is adapted to be engaged or disengaged from said power-driving unit such that another actuator unit may be operatively engaged to said power-driving unit.
